(19) United States
(12) Patent Application Publication
(10) Pub. No.: US 2018/0197195 A1
(43) Pub. Date: Jul. 12, 2018

(54) METHOD OF MANAGING A LOYALTY REWARDS PROGRAM

(71) Applicant: Mastercard International Incorporated, Purchase, NY (US)

(72) Inventors: Subrat Das, Odisha (IN); Rinku Purushottam Agrawal, Pune (IN)

(21) Appl. No.: 15/836,295

(22) Filed: Dec. 8, 2017

(30) Foreign Application Priority Data
Jan. 12, 2017 (SG) 10201700268Q

(51) Int. Cl. G06Q 30/02; G06Q 40/02

(52) U.S. Cl. CPC G06Q 30/0233; G06Q 40/02

(57) ABSTRACT

Disclosed is a method for managing a loyalty rewards program. The method comprises maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services. The method also comprises accruing interest on the at least one loyalty index recorded for each of the plurality of loyalty reward accounts, administering accrued interest for each of the plurality of loyalty reward accounts in accordance with rules of the loyalty rewards program and increasing the loyalty index associated with one of the plurality of loyalty reward accounts by a factor determined in response to the accrued interest on that loyalty index.

### CROSS-REFERENCE TO RELATED APPLICATION

This application is a U.S. National Stage filing under 35 U.S.C. § 119, based on and claiming benefit of and priority to SG Patent Application No. 10201700268Q filed Jan. 12, 2017.

### TECHNICAL FIELD

Various embodiments relate to a method of managing a loyalty rewards program.

### BACKGROUND ART

Loyalty rewards programs are marketing strategies designed to encourage consumers to continue to purchase or use the goods and services provided by the businesses associated with such loyalty reward programs. A variety of loyalty rewards programs exist, with different features and rewards schemes. A typical loyalty reward program implemented by a business or merchant generally includes a loyalty card which identifies the consumer as a member of the loyalty program. The loyalty card would be presented by the consumer at the point of transaction to the merchant. By presenting the card, the consumer would earn the right either to a discount on the current transaction or to an allocation of loyalty points associated with the purchase amount. Traditionally, the consumer can then use, at their own discretion the allocation of loyalty points to redeem certain rewards/benefits, or discount their subsequent purchases with the merchant. For example, a frequent flyer program is a loyalty rewards program associated with a particular airline, or airline alliance. An airline customer enrolled in the program would accumulate loyalty points known as frequent flyer miles each time the customer buys a flight linked to the frequent flyer program. The frequent flyer miles may be then be redeemed/exchanged for free flights, or other rewards such as an upgrade to business class seat.

Increasingly, loyalty rewards programs are regarded as a form of virtual currency. Such loyalty rewards programs capture significant monetary value, since loyalty points can be exchanged for goods or services. However, loyalty rewards programs are traditionally characterised by a unidirectional conversion of loyalty points to rewards, with the loyalty points expressed in notional values and rewards expressed as one or more short-term benefits.

Thus, a need exists to provide consumers with more options to utilise their earned loyalty rewards program points. Furthermore, other desirable features and characteristics will become apparent from the subsequent detailed description and the appended claims, taken in conjunction with the accompanying drawings and this background of the disclosure.

### SUMMARY OF INVENTION

A first aspect of the present invention provides a method for managing a loyalty rewards program. The method comprises maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services. The method also comprises accruing interest on the at least one loyalty index recorded for each of the plurality of loyalty reward accounts, administering accrued interest for each of the plurality of loyalty reward accounts in accordance with rules of the loyalty rewards program and increasing the loyalty index associated with one of the plurality of loyalty reward accounts by a factor determined in response to the accrued interest on that loyalty index.

The accrued interest earned may depend on one or more of: a duration over which the loyalty index remains unredeemed, an accumulative value of the loyalty index and growth of the loyalty index resulting from purchases made using the payment vehicle.

The method may further comprise determining whether a purchase made using the payment vehicle exceeds a predetermined threshold to qualify for increasing the loyalty index associated with one of the plurality of loyalty reward accounts, and increasing that loyalty index when the purchase is determined to qualify.

Each loyalty index recorded under each of the plurality of loyalty reward accounts may be linked to a merchant category from whom the purchases are made, such that each loyalty index recorded under each of the plurality of loyalty reward accounts is linked to a different merchant category.

The rules of the loyalty rewards program in respect of accruing interest on the at least one loyalty index recorded for each of the plurality of loyalty reward accounts may depend on the merchant category, so that each of the at least one loyalty index recorded under each of the plurality of loyalty reward accounts accrues interest at different rates.

The method may further comprise locating, for a new purchase made using the payment vehicle enrolled in the loyalty rewards program, the loyalty reward account linked to that payment vehicle, identifying the loyalty index recorded under the located loyalty reward account to be increased and increasing the identified loyalty index.

The increase of the identified loyalty index associated with the new purchase may depend on any one or more of: a financial amount of the new purchases, a duration between a previous purchase made using the payment vehicle and the new purchase, and the merchant from which the previous purchase was made.

The method may further comprise restricting a date of redemption of the loyalty index to a maturity date of the loyalty index. The maturity date may be adjustable.

The method may further comprise receiving a redemption request on the loyalty index, verifying that the redemption request falls after the maturity date, and deducting the loyalty index by an amount associated with the redemption request.

A second aspect of the present invention provides a system configured to facilitate the management of a loyalty rewards program. The system comprises at least one processor, and at least one memory including computer program code. The at least one memory and the computer program code are configured to, with the at least one processor, cause system at least to maintain a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services, accrue interest on the at least one loyalty index recorded for each of the plurality of loyalty reward accounts, administer accrued interest for each of the plurality of loyalty reward accounts in accordance with rules of the loyalty rewards program, and increase the loyalty index associated with one of the plurality of loyalty reward accounts by a factor determined in response to the accrued interest on that loyalty index.

The system may be further configured to accrue interest depending on one or more of: a duration over which the loyalty index remains unredeemed, an accumulative value of the loyalty index and growth of the loyalty index resulting from purchases made using the payment vehicle.

The system may also be configured to determine whether a purchase made using the payment vehicle exceeds a predetermined threshold to qualify for increasing the loyalty index associated with one of the plurality of loyalty reward accounts, and increase that loyalty index when the purchase is determined to qualify.

Each loyalty index recorded under each of the plurality of loyalty reward accounts may be linked to a merchant category from whom the purchases are made, such that each loyalty index recorded under each of the plurality of loyalty reward accounts is linked to a different merchant category.

The rules of the loyalty rewards program in respect of accruing interest on the at least one loyalty index recorded for each of the plurality of loyalty reward accounts may depend on the merchant category, so that each of the at least one loyalty index recorded under each of the plurality of loyalty reward accounts accrues interest at different rates.

The system may be further configured to locate, for a new purchase made using the payment vehicle enrolled in the loyalty rewards program, the loyalty reward account linked to that payment vehicle, identify the loyalty index recorded under the located loyalty reward account to be increased, and increase the identified loyalty index.

The increase of the identified loyalty index associated with the new purchase may depend on any one or more of: a financial amount of the new purchases, a duration between a previous purchase made using the payment vehicle and the new purchase, and the merchant from which the previous purchase was mad

The system may be further configured to restrict a date of redemption of the loyalty index to a maturity date of the loyalty index. The maturity date may be adjustable.

The system is further configured to receive a redemption request on the loyalty index, verify that the redemption request falls after the maturity date, and deduct the loyalty index by an amount associated with the redemption request.

A third aspect of the present invention provides a non-transitory computer readable medium having stored thereon an application which when executed by a computer causes the computer to perform steps comprising, maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services, accruing interest on the at least one loyalty index recorded for each of the plurality of loyalty reward accounts, administering accrued interest for each of the plurality of loyalty reward accounts in accordance with rules of the loyalty rewards program, and increasing the loyalty index associated with one of the plurality of loyalty reward accounts by a factor determined in response to the accrued interest on that loyalty index.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 shows a flowchart illustrating a method for managing a loyalty rewards program in accordance with embodiments of the invention.

FIG. 2 shows a schematic diagram of a transaction system with a loyalty rewards program management system, in accordance with embodiments of the invention.

FIG. 3 shows a schematic diagram of a system configured to facilitate the management of the loyalty rewards program in accordance with embodiments of the invention.

FIG. 4 shows a schematic of a computing device used to realise the loyalty rewards program management system of FIG. 3.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

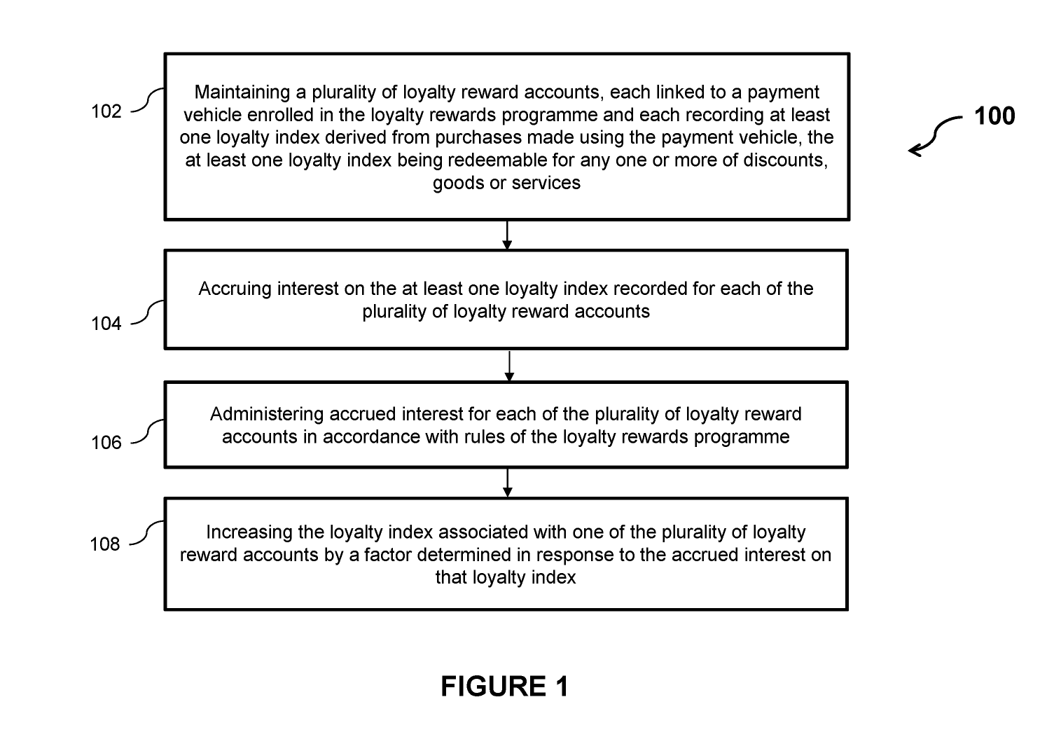

Such a server may be used to implement the method 100 shown in FIG. 1. FIG. 1 shows a flowchart illustrating a method 100 for managing a loyalty rewards program in accordance with embodiments of the invention. Embodiments of the present invention seek to enhance loyalty rewards programs by allowing consumers the flexibility of deferring their spending of their loyalty rewards points to a future date. The benefits of deferred spending may comprise interest in a form of loyalty points that are calculated and paid in set intervals (for example, annually or semi-annually) based on a principal amount of loyalty points, in addition to predetermined factors to be elaborated below.

The method 100 broadly includes:
step 102: Maintaining a plurality of loyalty reward accounts
step 104: Accruing interest for each of the plurality of loyalty reward accounts
step 106: Administering accrued interest for each of the plurality of loyalty reward accounts
step 108: Increasing a loyalty index associated with one of the plurality of loyalty reward accounts

At step 102, the method 100 for managing the loyalty rewards program includes managing a plurality of loyalty reward accounts. Each of the plurality of loyalty reward accounts may be linked to at least one payment vehicle enrolled in the loyalty rewards program. This linkage is such that when rewards are earned from use of the at least one payment vehicle, the record of the linked loyalty reward account is updated with the earned rewards. The at least one payment vehicle may comprise any of the following: a loyalty card, a credit card, a debit card, a digital card or information stored on electronic devices which identifies the card holder as a participant to the loyalty rewards program. The loyalty rewards program may be either maintained by a payment facilitator, or by merchants participating in the loyalty rewards program.

Each of the plurality of loyalty reward accounts records at least one loyalty index derived from purchases made using the payment vehicle. The loyalty index refers to an indicator used to measure an accumulated worth of the loyalty reward points recorded in each of the plurality of loyalty reward accounts. The at least one loyalty index is redeemable for any one or more of discounts, goods or services. In an embodiment, each of the at least one loyalty index may be linked to a different merchant participating in, or providing the loyalty rewards program. For example, the loyalty rewards program may have two participating merchants, Merchant A and Merchant B. A consumer who chose to enroll the at least one payment vehicle in the loyalty rewards program would have two loyalty indices, each separately linked to Merchant A and Merchant B. In other words, each loyalty index is linked to a separate merchant, the linkage allowing the identification of the merchant responsible for honouring redemption of the loyalty index.

In an alternate embodiment, each of the at least one loyalty index may be linked to a different merchant category from whom the purchases are made. For example, the loyalty rewards program may have three participating merchants, Merchants A, B and C. The merchants A and B may be classified under the retail category while the merchant C may be classified as providing financial and insurance services. Under this alternate embodiment, the first of the two loyalty indices would be linked to the retail category and the second would be linked to the financial and insurance services category. In other words, each loyalty index recorded under each of the plurality of loyalty reward accounts is linked to a different merchant category, the linkage allowing the identification of one or more of the merchants, belonging to the respective merchant category, which are responsible for honouring redemption of the loyalty index.

The value of each loyalty index depends primarily on spending of the at least one payment vehicle and redemption at a particular merchant, or at a particular merchant category. The at least one loyalty index may also be dependent on the spending of the at least one payment vehicle at another merchant or another merchant category. Accordingly, in embodiments of the present invention, the method 100 may also comprise determining, when the consumer makes a purchase using the at least one payment vehicle, whether the purchase made exceeds a predetermined threshold to qualify for increasing the loyalty index associated with one of the plurality of loyalty reward accounts, and with either the merchant or merchant category. If the purchase is determined to qualify, that loyalty index is increased.

For example, a particular loyalty reward account may be linked to a payment vehicle which is a credit card. The particular loyalty reward account comprises four loyalty indices, each associated with merchants A, B, C and D from whom the consumer purchases at different times. Merchants A and B are in the retail category, while merchants C and D are in the airline category. Tables 1 to 4 exemplify the loyalty index increase as a result of purchases made using the linked payment vehicle, where a separate loyalty index is linked to each merchant A, B, C and D.

Tables 1 to 4 below show that the consumer is awarded with one loyalty point (base value) when the consumer purchases a good or service with the merchant regardless of value of the purchase. In other words, the loyalty index increases by one point with each transaction. In alternate embodiments, a predetermined threshold may be required to qualify for increasing the index, that is, the purchase value may be required to exceed a predetermined threshold in order for loyalty points to be rewarded. In this example, the consumer is further rewarded with loyalty points according to the value of the purchase. Purchases below $10 are not rewarded with additional loyalty points, while purchases of value between $(11-50), $(51-100), $(101-500) and $(501-1000) are rewarded with loyalty points 1, 2, 5 and 10 respectively (in addition to base loyalty point of 1).

TABLE 1
Loyalty Index associated with Merchant A
Retail Merchant A

| | | | Loyalty | |
|---|---|---|---|---|
| | Purchase | Amount | Points | Loyalty |
| Date of Purchase | Amount | Range | Awarded | Index |
| Jan. 1^{st}, 2016 | $20 | $(11-50) | 1 (+1) | 2 |
| Jan. 10^{th}, 2016 | $75 | $(51-100) | 2 (+1) | 5 |
| Jan. 30^{th}, 2016 | $5 | $(0-10) | 0 (+1) | 6 |
| Feb. 2^{nd}, 2016 | $90 | $(51-100) | 2 (+1) | 9 |
| Feb. 14^{th}, 2016 | $20 | $(51-100) | 1 (+1) | 11 |

TABLE 2
Loyalty Index associated with Merchant B
Retail Merchant B

| | | | Loyalty | |
|---|---|---|---|---|
| | Purchase | Amount | Points | Loyalty |
| Date of Purchase | Amount | Range | Awarded | Index |
| Feb. 10th, 2016 | $45 | $(11-50) | 1 (+1) | 2 |

TABLE 3
Loyalty Index associated with Merchant C
Airline C

| | | | Loyalty | |
|---|---|---|---|---|
| | Purchase | Amount | Points | Loyalty |
| Date of Purchase | Amount | Range | Awarded | Index |
| Jan. 1^{st}, 2016 | $300 | $(101-500) | 5 (+1) | 6 |
| Jan. 10^{th}, 2016 | $250 | $(101-500) | 5 (+1) | 12 |
| Feb. 2^{nd}, 2016 | $600 | $(501-1000) | 10 (+1) | 23 |

TABLE 4
Loyalty Index associated with Merchant D
Airline D

| | | | Loyalty | |
|---|---|---|---|---|
| | Purchase | Amount | Points | Loyalty |
| Date of Purchase | Amount | Range | Awarded | Index |
| Jan. 30th, 2016 | $400 | $(101-500) | 5 (+1) | 6 |
| Feb. 10th, 2016 | $600 | $(501-1000) | 10 (+1) | 17 |

In an alternate embodiment of the present invention, the loyalty reward account may comprise loyalty indices each associated with a different merchant category. For example, a loyalty reward account may have two loyalty indices, one associated with retail category while the other is associated with the airline category.

In this example, which is illustrated by Tables 5 and 6 below, merchants W (retail) and Y (airline) are participants to the loyalty reward program, while merchants X (retail) and Z (airline) are not. When the consumer acquires goods or services using the linked payment vehicle from the merchants participating in the loyalty reward program, the consumer is rewarded with loyalty points according to the value of the purchase. Further, the consumer would be rewarded with an additional loyalty points (referred to as “continuity loyalty point”) if the merchant from whom the current purchase is made is the same as the previous merchant, or with a merchant participating in the loyalty rewards program, to encourage continued repeat purchases. Conversely, when the consumer acquires goods or services using the linked payment vehicle from the merchants that are not participants in the loyalty reward program, loyalty points are deducted from the loyalty reward account according to the value of the purchase. In the current example, loyalty points are not rewarded/deducted with purchases below $10, while purchases of value between $(11-50), $(51-100), $(101-500) and $(501-1000) are equivalent to the addition/deduction of loyalty points 1, 2, 5 and 10 respectively.

TABLE 5
Loyalty Index associated with Retail Merchant Category
Retail Category

| | | | | Loyalty | Continuity | |
|---|---|---|---|---|---|---|
| Date of | Purchase | | Amount | Points | Loyalty | Loyalty |
| Purchase | Amount | Merchant | Range | Awarded | Points | Index |
| Jan. 1^{st}, 2016 | $20 | W | $(11-50) | +1 | +1 | 2 |
| Jan. 10^{th}, 2016 | $75 | W | $(51-100) | +2 | +1 | 5 |
| Jan. 30^{th}, 2016 | $5 | W | $(0-10) | +0 | +1 | 6 |
| Feb. 2^{nd}, 2016 | $90 | W | $(51-100) | +2 | +1 | 9 |
| Feb. 10^{th}, 2016 | $45 | X | $(11-50) | −1 | 0 | 8 |
| Feb. 14^{th}, 2016 | $20 | W | $(11-50) | +1 | 0 | 9 |

TABLE 6
Loyalty Index associated with Airline Merchant Category
Airline Category

| | | | | Loyalty | Continuity | |
|---|---|---|---|---|---|---|
| Date of | Purchase | | Amount | Points | Loyalty | Loyalty |
| Purchase | Amount | Merchant | Range | Awarded | Points | Index |
| Jan. 1^{st}, 2016 | $300 | Y | $(101-500) | +5 | +1 | 6 |
| Jan. 10^{th}, 2016 | $250 | Y | $(101-500) | +5 | +1 | 12 |
| Jan. 30^{th}, 2016 | $400 | Z | $(101-500) | −5 | 0 | 7 |
| Feb. 2^{nd}, 2016 | $600 | Y | $(501-1000) | +10 | 0 | 17 |

The above examples also demonstrate that method 100 may further comprise locating, for a new purchase made using the payment vehicle linked to the loyalty reward account, identifying the loyalty index recorded under the located loyalty reward account to be increased, and increasing the identified loyalty index. Broadly, the increase (or decrease) of the identified loyalty index associated with the new purchase thus depends on any one or more of: a financial amount of the new purchases, the merchant from which the previous purchase was made, and the merchant from which the current purchase is made. Further, the increase (or decrease) of the identified loyalty index associated with the new purchase may also be dependent on a duration between a previous purchase made using the payment vehicle and the new purchase.

At step 104, interest on the at least one loyalty index recorded for each of the plurality of loyalty reward accounts is accrued. In an embodiment, the accrued interest earned depends on one or more of the following factors: a duration over which the loyalty index remains unredeemed, an accumulative value of the loyalty index and growth of the loyalty index resulting from purchases made using the at least one payment vehicle. Further, the accrued interest earned may also depend on rules of the loyalty reward program and the merchant category. For example, a tiered interest rate may apply for the loyalty index which remains unredeemed for a long period of time. The longer the duration over which the loyalty index remains unredeemed, the higher the interest rate applied on the loyalty index. For instance, a first tier may include loyalty index which remains unredeemed for 30 days, and an interest rate of 0.5% would apply; while a second tier may include loyalty index which remains unredeemed for 90 days, and an interest rate of 1.0% would apply. Further, in the loyalty reward program, the consumer may restrict a date of redemption of the loyalty index to a maturity date of the loyalty index. In other words, there exists a lock-in period for the loyalty index. The consumer may choose to specify different lock-in periods (or maturity dates) for each of the loyalty index recorded in his loyalty reward account. Alternatively, the consumer may choose to restrict a same date of redemption for all the loyalty index recorded in the loyalty reward account. Thus, the maturity date is adjustable. However, a higher interest rate would apply if a longer lock-in period is selected.

Different merchants, or different merchant categories may apply different interest rates on the loyalty index of step 102. In other words, the rules of the loyalty rewards program in respect of accruing interest on the at least one loyalty index recorded for each of the plurality of loyalty reward accounts depends on either the merchant or the merchant category that honours redemption made against the loyalty index, and each of the at least one loyalty index can accrue interest at different rates.

At step 106, accrued interest is administered for each of the plurality of loyalty reward accounts in accordance with rules of the loyalty rewards program. The administration of accrued interest for each of the plurality of loyalty reward accounts may comprise determining the manner in which the interest is earned. The determination may be based on the rules of the loyalty rewards program, which include parameters that are agreed upon by merchants who honour the redemption of the loyalty index. For example, the accrued interest may be administered in a form of loyalty points which increases the loyalty index based on a predetermined interest rate, in accordance with the rules of the loyalty reward program as described above. If a particular loyalty index records a present loyalty point of 100, and an interest rate of 2% per annum is applicable, two loyalty points would be accrued in respect of the particular loyalty index for the year, subject to a multiplier which would be described below.

At step 108, the loyalty index associated with one of the plurality of loyalty reward accounts is increased by a factor determined in response to the accrued interest on that loyalty index. In other words, the step 108 may comprise firstly, determining if the loyalty index associated with one of the plurality of loyalty reward accounts qualifies for a multiplied interest rate, and if the loyalty index is determined to qualify, increasing the loyalty index with the multiplied interest rate. A predetermined multiplier may be applied to the accrued interest in respect of the particular loyalty index, in accordance with the rules of the loyalty rewards program. For example, according to the rules, if the loyalty index is higher than a stated value, a multiplier of more than 1 will apply to the accrued index. Conversely, if the loyalty index is below a stated value, the accrued interest is applied to the interest rate without any multipliers. Extending the above-mentioned example, the loyalty rewards program may stipulate that loyalty indices recording loyalty points of more than 50 may earn a multiplier of 1.1 on the accrued interest. Accordingly, a final interest rate of 2.2 would be applied to the loyalty index. Table 7 below illustrates the above example.

TABLE 7
Multiplier and Accrued Interest

| | Loyalty | Accrued | | Loyalty | Total Loyalty |
|---|---|---|---|---|---|
| Year | Index | Interest | Multiplier | Point | Index |
| 2015 | 100 | 2% | 1.1 | 2.2 | 100 + 2.2 = |
| | | | | | 102.2 |

In an alternative embodiment, the step 108 may comprise first determining if any accumulated loyalty index may enjoy a higher interest rate, and then increasing the loyalty index associated with one of the plurality of loyalty reward accounts by a sum of the accrued interest administered in the step 106 and an additional bonus interest according to the rules of the loyalty rewards program. For example, the rules of the loyalty rewards program may specify that bonus interest of 5% would be earned on any incremental loyalty account balance, that is, the difference between the current and the previous year's balance. Table 8 below illustrates the above example.

TABLE 8
Accrued Interest (Base) and Incremental Interest (Bonus)

| | | | | Incremental | | | |
|---|---|---|---|---|---|---|---|
| | | Accrued | Accrued | Loyalty | | Bonus | Total |
| | Loyalty | Interest | Loyalty | Account | Bonus | Loyalty | Loyalty |
| Year | Index | (Base) | Points | Balance | Interest | Points | Index |
| 2016 | 100 | 2% | 2 | 20 | 5% | 1 | 100 + 3 = 103 |

The method 100 for managing a loyalty rewards program may also comprise receiving a redemption request on the loyalty index; verifying that the redemption request falls after the maturity date and deducting the loyalty index by an amount associated with the redemption request.

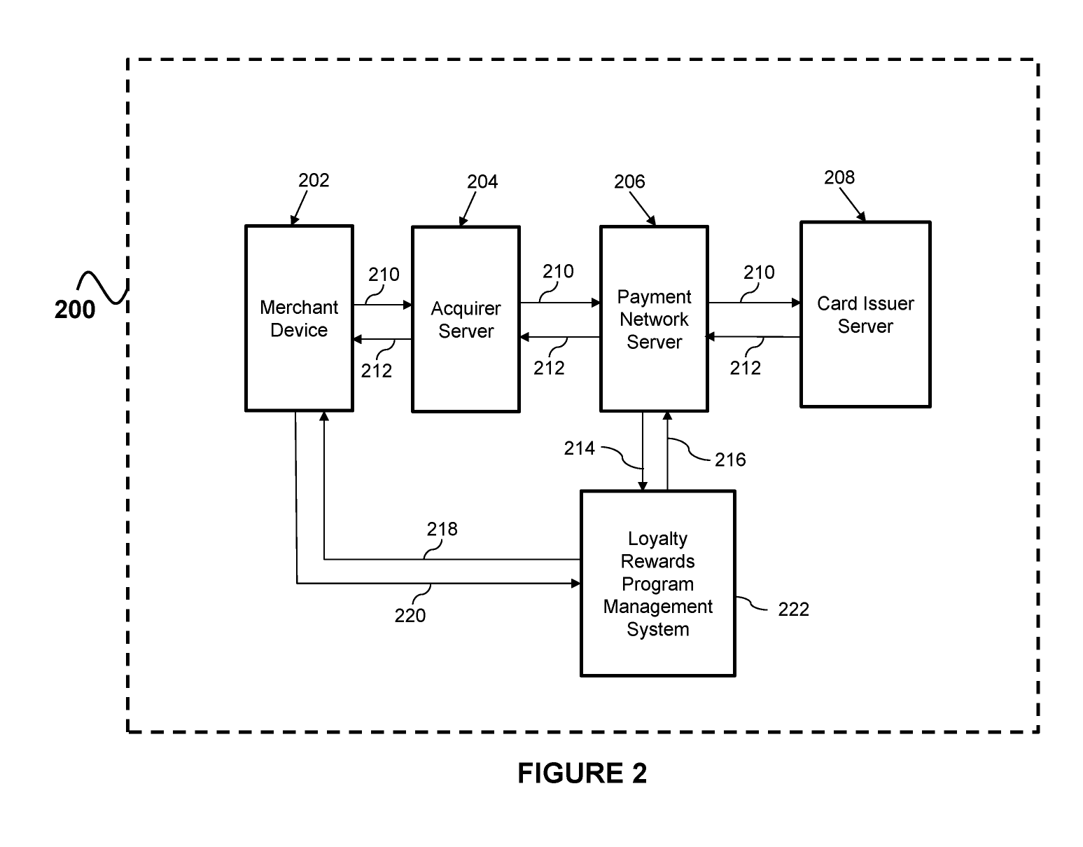

FIG. 2 shows a schematic diagram of a payment transaction system 200 with a loyalty rewards program management system 222 in which the method 100 of FIG. 1 is implemented.

The payment transaction system 200 processes payment transactions and comprises a merchant device 202, an acquirer server 204, the payment network server 206 and an issuer server 208. The merchant device 202 is in direct communication with the acquirer server 204, which is in turn in direct communication with the payment network server 206. The issuer server 208 is also in direct communication with the payment network server 206.

The merchant device 202 is typically associated with a merchant who is a party to a payment transaction. The merchant device 202 may be any transaction acquiring device such as a point-of-sale (POS) terminal, or an automated teller machine (ATM) and the like, to which the consumer a request to initiate the transaction. A transaction request 210 is generated by and transmitted from the merchant device to the acquirer server 204 once the payment transaction is initiated.

The acquirer server 204 is typically associated with an acquirer who may be an entity (e.g. a company or organization) which provides and administers an account of the merchant. Examples of the acquirer include a bank and/or other financial institution. The acquirer server 204 may include one or more computing devices that are used to establish communication with another server by exchanging messages with and/or passing information to the other server. The transaction request 210 sent from the merchant device 202 is received and recorded by the acquirer server 204, which then forwards the transaction request 210 to the payment network server 206 based on information contained within the transaction request 210.

The payment network server 206 is typically associated with and operated by a payment facilitator. For example, the payment network server 206 may be a Banknet network operated by the payment facilitator (e.g. MasterCard) which is an entity that processes transactions, clear and settle funds for payments between two other entities (e.g. two banks). The transaction request 210 forwarded by the acquirer server 204 is received by the payment network server 206, which subsequently records the request 210 and routes the transaction request 210 to the issuer server 208 based on the information contained within the transaction request 210.

The issuer server 208 is generally associated with an issuer, i.e. the issuer of the payment vehicle (e.g. credit card, debit card or digital wallet) used to initiate the financial transaction. The issuer server 208 receives the transaction request 210, approves or denies the transaction request 210 and routes an authorization response 212 back to the payment network server 206. The payment network server 206 records and forwards the authorization response 212 to the acquirer server 204 which then sends the authorization response 212 to the merchant device 202.

As mentioned above, the financial transaction request 210 and the authorization response 212 of each financial transaction are recorded by the payment network server 206. Each of the financial transactions (i.e. payment transaction data) may be stored on the one or more databases of the payment facilitator. In accordance with embodiments of the invention, the loyalty rewards program may be either maintained by a payment facilitator, by merchants participating in the loyalty rewards program, or by a third party that manages the loyalty rewards program on behalf of the participating merchants.

In the first instance, when the method 100 as elaborated is managed by the payment facilitator, the payment network server 206 routes message 214 containing transaction information comprising details of transaction request 210 and authorization response 212 to loyalty rewards program management system 222. The loyalty rewards program management system 222 then sends acknowledgement message 216 back to the payment network server 206. Thus, it is possible for increment and updates to the loyalty index to be based on a real time transaction basis. The loyalty rewards program management system 222 may also share updates 218 with merchant device 202 which may comprise merchant systems (not shown) that also may administrate components of the loyalty rewards program not managed by the loyalty rewards program management system 222. The updates 218 may be shared with the merchant systems at a periodic basis, and the updates 218 may include information on the relevant loyalty index of the consumers enrolled in the loyalty rewards program.

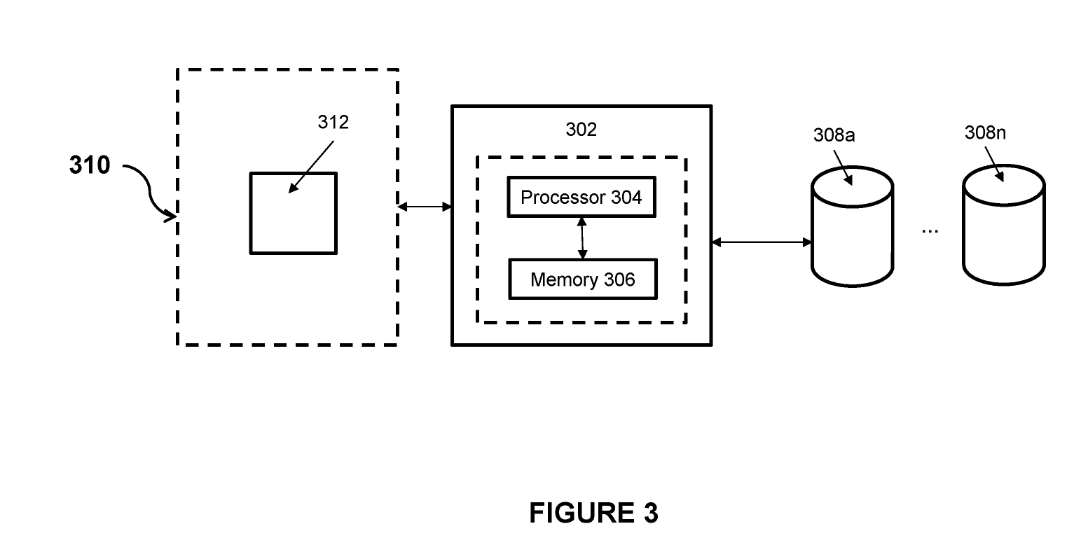

FIG. 3 shows a schematic diagram of a system configured to facilitate the management of the loyalty rewards program in accordance with embodiments of the invention. The system 300 comprises a computing device 302, one or more databases 308a . . . 308n and a mobile device 310. The computing device 302 may be a component of the loyalty rewards program management system 222 of FIG. 2. The mobile device 310 directly communicates with the computing device 302. The mobile device 310 is typically associated with a consumer who manages the loyalty reward account. The mobile device 310 may be, for example, a mobile terminal such as a laptop computer, smartphone, smartwatch or a tablet with an advanced mobile operating system, such as Windows of Microsoft, iOS of Apple Inc. or Android of Google Inc. The operating system may host one or more mobile applications, where the one or more mobile applications includes a loyalty reward account management application which the consumer can use to access one or more of his loyalty reward accounts shown on user input interface 312. For example, the consumer may use the mobile device 310 to restrict or adjust the date of redemption of the loyalty index to a maturity date of the loyalty index. In embodiments of the invention, the consumer would be able to see, using the one or more mobile applications on the mobile device 310, all the merchants, or merchant categories he has been loyal to, and all merchants who are participants to the loyalty reward program. The consumer may also see all accrued benefits through the one or more mobile applications on the mobile device 310.

The one or more databases 308a . . . 308n store information about the loyalty reward program. For example, with the consumers' consent, the stored information may comprise aggregate data such as purchase information, spending behaviour, and preferences of the consumers. In embodiments, the stored information can be relayed to merchants who would be able to use the stored information, together with the loyalty index, to tailor marketing offers for select consumer categories.

The memory 306 and the computer program code, with processor 304, are configured to cause the computing device 302 to, (i) maintain a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services and (ii) accrue interest on the at least one loyalty index recorded for each of the plurality of loyalty reward accounts. The system also (iii) administers accrued interest for each of the plurality of loyalty reward accounts in accordance with rules of the loyalty rewards program and (iv) increase the loyalty index associated with one of the plurality of loyalty reward accounts by a factor determined in response to the accrued interest on that loyalty index.

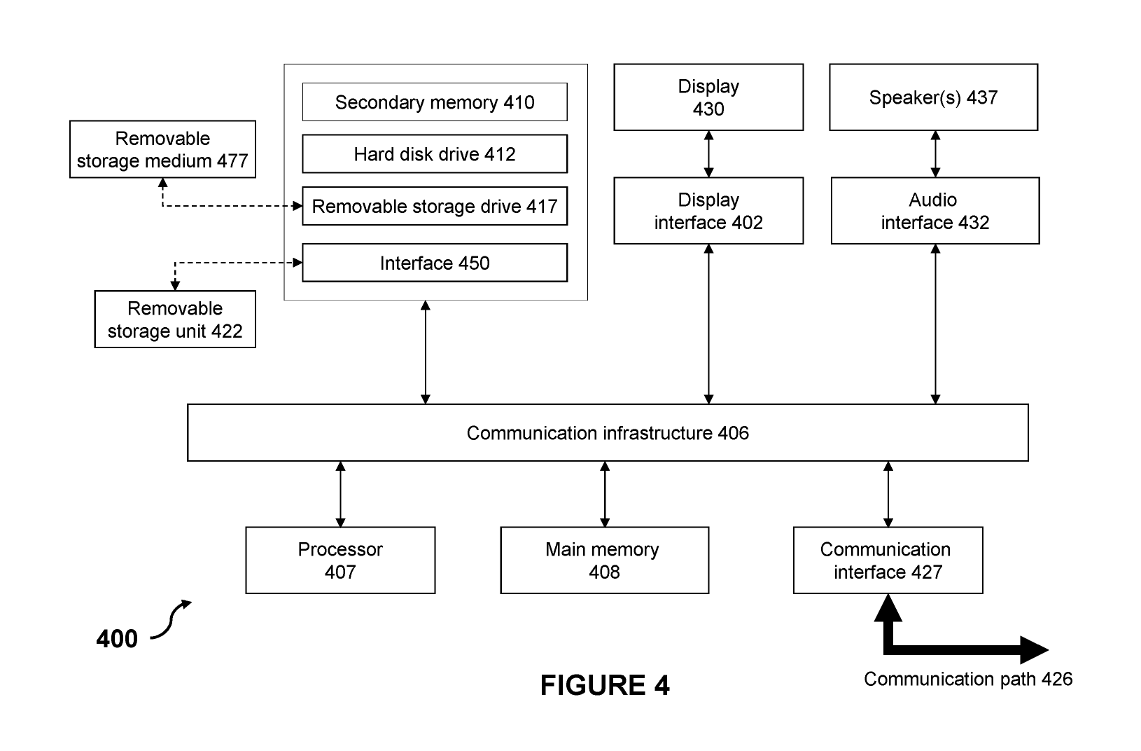

FIG. 4 depicts an exemplary computing device 400, hereinafter interchangeably referred to as a computer system 400, where one or more such computing devices 400 may be used to execute the method of FIG. 1. The exemplary computing device 400 can be used to implement the transaction system 200 shown in FIG. 2. The following description of the computing device 400 is provided by way of example only and is not intended to be limiting.

As shown in FIG. 4, the example computing device 400 includes a processor 407 for executing software routines. Although a single processor is shown for the sake of clarity, the computing device 400 may also include a multi-processor system. The processor 407 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 417, which may include a magnetic tape drive, an optical disk drive, a solid state storage drive (such as a USB flash drive, a flash memory device, a solid state drive or a memory card), or the like. The removable storage drive 417 reads from and/or writes to a removable storage medium 477 in a well-known manner. The removable storage medium 477 may include magnetic tape, optical disk, non-volatile memory storage medium, or the like, which is read by and written to by removable storage drive 417. As will be appreciated by persons skilled in the relevant art(s), the removable storage medium 477 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 427. The communication interface 427 allows software and data to be transferred between computing device 400 and external devices via a communication path 426. In various embodiments of the inventions, the communication interface 427 permits data to be transferred between the computing device 400 and a data communication network, such as a public data or private data communication network. The communication interface 427 may be used to exchange data between different computing devices 400 which such computing devices 400 form part an interconnected computer network. Examples of a communication interface 427 can include a modem, a network interface (such as an Ethernet card), a communication port (such as a serial, parallel, printer, GPIB, IEEE 1394, RJ45, USB), an antenna with associated circuitry and the like. The communication interface 427 may be wired or may be wireless. Software and data transferred via the communication interface 427 are in the form of signals which can be electronic, electromagnetic, optical or other signals capable of being received by communication interface 427. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 437.

As used herein, the term “computer program product” may refer, in part, to removable storage medium 477, removable storage unit 422, a hard disk installed in storage drive 412, or a carrier wave carrying software over communication path 426 (wireless link or cable) to communication interface 427. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 427. Such computer programs, when executed, enable the computing device 400 to perform one or more features of embodiments discussed herein. In various embodiments, the computer programs, when executed, enable the processor 407 to perform features of the above-described embodiments. Accordingly, such computer programs represent controllers of the computer system 400.

Software may be stored in a computer program product and loaded into the computing device 400 using the removable storage drive 417, the storage drive 412, or the interface 450. The computer program product may be a non-transitory computer readable medium. Alternatively, the computer program product may be downloaded to the computer system 400 over the communications path 426. The software, when executed by the processor 407, causes the computing device 400 to perform the necessary operations to execute the method 100 as shown in FIG. 1.

It is to be understood that the embodiment of FIG. 4 is presented merely by way of example to explain the operation and structure of the transaction system 100. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the servers as described in the above embodiments.

When the computing device 400 is configured to realise the loyalty rewards program management system 222 to manage the loyalty rewards program, the loyalty rewards program management system 222 will have a non-transitory computer readable medium having stored thereon an application which when executed causes the loyalty rewards program management system 222 to perform steps comprising: (i) maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services, (ii) accruing interest on the at least one loyalty index recorded for each of the plurality of loyalty reward accounts, (iii) administering accrued interest for each of the plurality of loyalty reward accounts in accordance with rules of the loyalty rewards program, and (iv) increasing the loyalty index associated with one of the plurality of loyalty reward accounts by a factor determined in response to the accrued interest on that loyalty index.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for managing a loyalty rewards program, the method comprising:
maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services;
accruing interest on the at least one loyalty index recorded for each of the plurality of loyalty reward accounts;
administering accrued interest for each of the plurality of loyalty reward accounts in accordance with rules of the loyalty rewards program; and
increasing the loyalty index associated with one of the plurality of loyalty reward accounts by a factor determined in response to the accrued interest on that loyalty index.

2. The method of claim 1, wherein the accrued interest earned depends on one or more of: a duration over which the loyalty index remains unredeemed, an accumulative value of the loyalty index and growth of the loyalty index resulting from purchases made using the payment vehicle.

3. The method of claim 1, further comprising:
determining whether a purchase made using the payment vehicle exceeds a predetermined threshold to qualify for increasing the loyalty index associated with one of the plurality of loyalty reward accounts; and
increasing that loyalty index when the purchase is determined to qualify.

4. The method of claim 1, wherein each loyalty index recorded under each of the plurality of loyalty reward accounts is linked to a merchant category from whom the purchases are made, such that each loyalty index recorded under each of the plurality of loyalty reward accounts is linked to a different merchant category.

5. The method of claim 4, wherein the rules of the loyalty rewards program in respect of accruing interest on the at least one loyalty index recorded for each of the plurality of loyalty reward accounts depends on the merchant category, so that each of the at least one loyalty index recorded under each of the plurality of loyalty reward accounts accrues interest at different rates.

6. The method of claim 4, further comprising
locating, for a new purchase made using the payment vehicle enrolled in the loyalty rewards program, the loyalty reward account linked to that payment vehicle;
identifying the loyalty index recorded under the located loyalty reward account to be increased; and
increasing the identified loyalty index.

7. The method of claim 6, wherein the increase of the identified loyalty index associated with the new purchase depends on any one or more of: a financial amount of the new purchases, a duration between a previous purchase made using the payment vehicle and the new purchase, and the merchant from which the previous purchase was made.

8. The method of claim 1, further comprising
restricting a date of redemption of the loyalty index to a maturity date of the loyalty index.

9. The method of claim 9, wherein the maturity date is adjustable.

10. The method of claim 8, further comprising
receiving a redemption request on the loyalty index;
verifying that the redemption request falls after the maturity date; and
deducting the loyalty index by an amount associated with the redemption request.

11. A system configured to facilitate the management of a loyalty rewards program, the system comprising:
at least one processor; and
at least one memory including computer program code;
the at least one memory and the computer program code configured to, with the at least one processor, cause system at least to:
maintain a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services;
accrue interest on the at least one loyalty index recorded for each of the plurality of loyalty reward accounts;
administer accrued interest for each of the plurality of loyalty reward accounts in accordance with rules of the loyalty rewards program; and
increase the loyalty index associated with one of the plurality of loyalty reward accounts by a factor determined in response to the accrued interest on that loyalty index.

12. The system of claim 11, wherein the system is further configured to accrue interest depending on one or more of: a duration over which the loyalty index remains unredeemed, an accumulative value of the loyalty index and growth of the loyalty index resulting from purchases made using the payment vehicle.

13. The system of claim 11, wherein the system is further configured to:
determine whether a purchase made using the payment vehicle exceeds a predetermined threshold to qualify for increasing the loyalty index associated with one of the plurality of loyalty reward accounts; and
increase that loyalty index when the purchase is determined to qualify.

14. The system of claim 11, wherein each loyalty index recorded under each of the plurality of loyalty reward accounts is linked to a merchant category from whom the purchases are made, such that each loyalty index recorded under each of the plurality of loyalty reward accounts is linked to a different merchant category.

15. The system of claim 11, wherein the rules of the loyalty rewards program in respect of accruing interest on the at least one loyalty index recorded for each of the plurality of loyalty reward accounts depends on the merchant category, so that each of the at least one loyalty index recorded under each of the plurality of loyalty reward accounts accrues interest at different rates.

16. The system of claim 14, wherein the system is further configured to:
locate, for a new purchase made using the payment vehicle enrolled in the loyalty rewards program, the loyalty reward account linked to that payment vehicle;
identify the loyalty index recorded under the located loyalty reward account to be increased; and
increase the identified loyalty index.

17. The system of claim 16, wherein the increase of the identified loyalty index associated with the new purchase depends on any one or more of: a financial amount of the new purchases, a duration between a previous purchase made using the payment vehicle and the new purchase, and the merchant from which the previous purchase was made.

18. The system of claim 11, wherein the system is further configured to restrict a date of redemption of the loyalty index to a maturity date of the loyalty index.

19. The system of claim 18, wherein the maturity date is adjustable.

20. The system of claim 18, wherein the system is further configured to:
receive a redemption request on the loyalty index;
verify that the redemption request falls after the maturity date; and
deduct the loyalty index by an amount associated with the redemption request.

21. A non-transitory computer readable medium having stored thereon an application which when executed by a computer causes the computer to perform steps comprising:
maintaining a plurality of loyalty reward accounts, each linked to a payment vehicle enrolled in the loyalty rewards program and each recording at least one loyalty index derived from purchases made using the payment vehicle, the at least one loyalty index being redeemable for any one or more of discounts, goods or services;
accruing interest on the at least one loyalty index recorded for each of the plurality of loyalty reward accounts,
administering accrued interest for each of the plurality of loyalty reward accounts in accordance with rules of the loyalty rewards program; and
increasing the loyalty index associated with one of the plurality of loyalty reward accounts by a factor determined in response to the accrued interest on that loyalty index.
